(19) United States
(12) Patent Application Publication
(10) Pub. No.: US 2009/0214721 A1
(43) Pub. Date: Aug. 27, 2009

(54) Food products

(76) Inventor: Bruce Sack, Farmington Hills, MI (US)

Correspondence Address: Bruce Sack, Suite 250, 28800 Orchard Lake Rd., Farmington Hills, MI, 48334, US

(21) Appl. No.: 12/378,717

(22) Filed: Feb. 19, 2009

Related U.S. Application Data
(60) Provisional application No. 61/066,816, filed on Feb. 22, 2008.

(51) Int. Cl. A23L 1/064

(52) U.S. Cl. 426/102

(57) ABSTRACT

A food product comprising a strip of fruit leather rolled into a roll, and an outer wrapper of a food edible material enclosing said roll.

### RELATED APPLICATIONS

This application claims the benefit of priority from U.S. Provisional Patent Application No. 61/066,816 filed on Feb. 22, 2008, the contents of which are incorporated herein by reference.

### FIELD AND BACKGROUND OF THE INVENTION

The present inventions relates to food products, and particularly to a fruit product useful as a healthy and beneficial food snack, and/or as an aid for withdrawing from smoking cigarettes or other tobacco products.

Fruit leathers, sometimes referred to as fruit rolls, are popular dried food snacks formed when fruit is pureed, generally from a concentrated, cooked, dried, and rolled or cut out into strips for easy storage and packaging. Such articles are widely used as food snacks. They have a relatively long life and do not require refrigeration. Such fruit leather products have become widely popular in the recent years because they are more helpful than other confections as they are produced from fruit having many natural vitamins, usually with the addition of vitamin C to compensate for the loss of this vitamin during the fruit drying process.

### OBJECTS AND BRIEF SUMMARY OF THE PRESENT INVENTION

An object of the present invention is to provide a food product made essentially of fruit leather in a form which is convenient to carry and to eat, whenever desired, and which is particularly attractive to children.

Another object of the invention is to provide such a food product which can also be used in aiding a smoker in withdrawing from cigarettes or other tobacco products.

According to a broader aspect of the present invention, there is to provide such a food product comprising a strip of fruit leather rolled into a roll; and an outer wrapper of a food edible material enclosing the roll.

According to the preferred embodiments of the invention described below, the food product is configured to simulate a cigarette. In addition, the outer wrapper is made of an edible rice material.

In one described preferred embodiment, the strip of fruit leather is void of nicotine such as to be safely edible by children. In another described embodiment, the strip of fruit leather includes an amount of nicotine sufficient to aide withdrawal from smoking cigarettes and other tobacco products.

Further features and advantages of the invention will be described below.

### BRIEF DESCRIPTION OF THE DRAWINGS

The invention is herein described, by way of example only, with reference to the accompanying drawings, wherein:

FIG. 1 is a plane view illustrating a fruit leather strip useful in making a food product according to the present invention;

FIG. 2 illustrates one form of food product constructed in accordance with the present invention including the fruit leather strip of FIG. 1 enclosed within a wrapper of edible material; and

FIG. 3 is an end view of the food product of FIG. 2.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details then necessary to enable one skilled in the art, using routine skill and design, to understand and practice the described invention. It is to be further understood that the embodiments described are for purposes of example only, and that the invention is capable of being embodied in other forms and applications then described herein.

### DESCRIPTION OF PREFERRED EMBODIMENTS

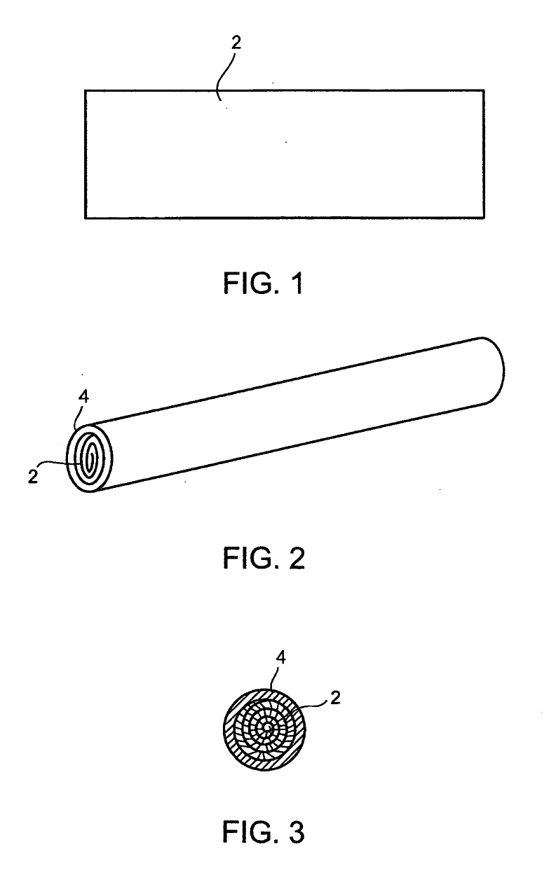

With references to FIG. 1, there is illustrated a fruit leather strip, generally designated 2, made in any conventional manner and from any conventional combination of ingredients. Since many different methods of making such fruit leather strips, as well as combinations of different ingredients used in them, are well-known and available from published literature, further details of the composition or of the method of making strips 2 are not set forth herein.

FIG. 2 illustrates the fruit leather strip of FIG. 1 in rolled form and enclosed by a wrapper 4 of an edible material, preferably of a rice paper. As can be seen in FIG. 2, as well as in FIG. 3, the produced fruit leather product shown in these figures is configured to simulate a cigarette. Thus, a plurality of such fruit leather products may be packaged in packages simulating conventional cigarette packs for convenient carrying and for convenient availability whenever desired to eat such an article as a food snack. The simulation of the illustrated fruit leather product as a cigarette also has an appeal to some children desiring to simulate an adult smoking a cigarette.

Since the main purpose of the illustrated fruit leather product is as a healthy snack-food, such food products may be carried in a very convenient manner and conveniently eaten whenever desired. Also as indicated above, it may have a special attraction to some children, hence they enable the user to simulate an adult smoking a cigarette.

As further indicated above, another potential use of the fruit leather article illustrated in the drawings is as an aid for withdrawing from smoking cigarettes or the use of other tobacco products. Thus, nicotine-containing medications have been used for smoking cessation, such as nicotine patches, nicotine gums, nicotine inhalers, and nicotine nasal sprays. By including nicotine in the fruit leather strip 2 of the illustrated article, such an article can also be used, as a nicotine patch for example, to aid in withdrawing from smoking cigarettes are using other tobacco products

While the invention has been described with respect to preferred embodiments, it will be appreciated that these are set forth merely for purposes of example, and that many other variations, modifications, and applications of the invention may be made. For example, the outer wrapper could be mint leaf or meringue instead of rice paper. In addition, the fruit leather strip 2 could include many different types of additives as are commonly included in various fruit leather products.

What is claimed is:

1. A food product comprising a strip of fruit leather rolled into a roll; and an outer wrapper of a food edible material enclosing said roll.

2. The food product according to claim 1, wherein said food product is configured to simulate a cigarette.

3. The food product according to claim 2, wherein said outer wrapper is made of an edible rice material.

4. The food product according to claim 2, wherein said strip of fruit leather is void of nicotine such as to be safely edible by children or other non-smokers.

5. The food product according to claim 2, wherein said strip of fruit leather includes a sufficient quantity of nicotine so as to aid withdrawal from smoking cigarettes or consuming other tobacco products.
